(19) United States
(12) Patent Application Publication
(10) Pub. No.: US 2004/0074341 A1
(43) Pub. Date: Apr. 22, 2004

(54) CHAMPAGNE CORK REMOVER

(76) Inventor: Carl T. McLuen, Sequim, WA (US)

Correspondence Address: CARL T. McLUEN, 455 WOODCOCK ROAD, SEQUIM, WA, 98382, US

(21) Appl. No.: 10/271,381

(22) Filed: Oct. 16, 2002

(51) Int. Cl. B67B 7/18

(52) U.S. Cl. 81/3.44

(57) ABSTRACT

A hand tool with a U-shaped cutout to slide into the groove at the top of a champagne bottle, and pivoted lever-arms above the cutout straddling the stopper of the bottle. Extractor links connected to these lever-arms, are hinged at the outer end, and have teeth across the inner end, which is aligned with the stopper. Squeezing the lever-arms together causes the extractor links to engage and compress that part of the stopper exposed above the top of the bottle. The extractor links are angled upward toward the toothed end, so that the resulting combined upward force of the two links on opposite sides of the stopper, cause it to be extruded upward. Repeated actuations may be used to remove the stopper completely. The tool grips, and retains the stopper when completely closed.

### CROSS REFERENCE TO RELATED APPLICATIONS

(Not applicable)

### FEDERALLY SPONSORED R&D

(Not applicable)

### BACKGROUND

1. Field of the Invention

This invention relates to opening champagne bottles, and the like, by applying a force to the exposed part of the cork, or plastic, stopper.

2. Prior Art

A number of devices have been patented to accomplish this task, most of which attempt to pry or pull the stopper out by exerting a force between the top of the bottle and the enlarged part of the cork, which is exposed. Simple lever systems such as those found in U.S. Pat. No. 4,598,613 Jul. 8, 1986 to Frederick W. Baum, U.S. Pat. No. 4,590,821 May 27, 1986 to James C. Olson, and U.S. Pat. No. 4,680,993 Jul. 21, 1987 to Jack M. Feliz, are examples of such devices. Geared lever systems are also used in some designs, such as found in U.S. Pat. No. 4,750,391 Jun. 14, 1988 to Stanley L. Sweath, and U.S. Pat. No. 4,947,711 Aug. 4, 1990 to Ben F. Glebeler. A cranked threaded shaft mated with a threaded tubular column are used to exert the force in U.S. Pat. No. 5,040,437 Aug. 20, 1991 to John H. Mueller.

In all of these, the problem is not the force required to dislodge the cork stopper, but rather it is in the means of applying it to the soft and frangible part of the cork which is exposed. In some prior art such as is found in U.S. Pat. No. 4,875,398 Oct. 24, 1989 to Cleveland B. Crudington, the stopper must be partially raised to enable the tool to be inserted under it. Some require that a thin tool be forced between the top of the bottle and the bulge of the cork, and others rely on sharpened tongs as is noted on U.S. Pat. No. 5,000,063 Mar. 19, 1991 to George Federighi, and U.S. Pat. No. 4,708,033 Nov. 24, 1987 toLester E. Eash. One champagne opener found on the market is available from Franmara, Inc. of Salinas, Calif. This heavy tool has a large tooth on each of two hinged handles. The instructions are to drive these into the cork, and to twist the cork thus gripped, in opposite direction to the bottle, until internal pressure pushes the cork out.

Champagne corks are the tightest before the initial displacement, which breaks the bond to the bottle created over weeks or months of storage. Teeth forced into the uncompressed cork can tear or fracture the cap, leaving even less to work with. Most champagne is opened at the table in restaurants or private homes, and large complicated machines, such as that of John Mueller noted above, are unsuitable for such use.

Most of these prior art devices fail to achieve their objective due to the problem of effectively connecting to the cork stopper without damaging it. Tools that try to twist it loose can easily shear the cap off so that only a cork screw can be used to try to save it. It is necessary to grip the cork firmly over an area of that portion exposed, and to compress and lift it slowly and steadily out of the bottle. The Cork Remover described herein, does just that.

### SUMMARY

The present invention is comprised of a simple pliers type tool which can grip a champagne stopper firmly on opposite sides, and force it upward without fracturing the cork, or requiring much strength or effort. This tool can retain the stopper as it is removed.

### OBJECTS AND ADVANTAGES

Accordingly, the objects and advantages of my invention are:

a) to provide a champagne cork remover which can grip and raise a champagne cork with little strength or effort required.

b) to enable one hand operation of said cork remover so that the other hand is free to support the bottle, or to assure that pressure does not force out the stopper prematurely

c) to provide a tool which can retain the cork or other stopper as it exits the bottle.

d) to provide a simple, uncomplicated design which can be produced and sold at low cost.

e) To provide a device which can also remove plastic bottle stoppers used for sparkling cider, and similar beverages, sold in champagne size bottles.

f) to enable wine stewards to quickly serve champagne formally, and with ease and grace, in restaurants and dining rooms.

g) to provide a tool which requires no maintenance or adjustment, and is constructed of corrosion-free materials.

### BRIEF DESCRIPTION OF THE DRAWINGS

FIG. 1 is an end view of the cork remover.

FIG. 2 is a side view of the cork remover.

FIG. 3 is a plan view of the champagne cork remover, showing the plier-like lever-arms, and the attachment to the base plate.

FIG. 4a is a section view through B-B, showing a stop pin and its pocket, which limits the angular motion of each lever-arm.

FIG. 4b is a section view through C-C, showing a lever-arm pivot and its' retaining screw, which connects each lever-arm to the base plate.

FIG. 5a is a section view through A-A, showing the position and shape of the extractor links, which compress and raise the champagne cork when the lever- arms are closed towards each other. A phantom view of a champagne bottle and its cork is shown as it would be positioned in the cork remover.

FIG. 5b is the same as 5a above, except that the lever-arms are partially closed so that the resulting motion of the extractor links to pinch and raise the cork are illustrated. The resulting annular space between the head of the cork and the top of the bottle is evident.

FIG. 5c shows the sectional view of 5b above with the cork remover repositioned atop the bottle, in the space created between the cork head and the bottle top, by the initial operation of the cork remover as shown in FIG. 5b. The lever-arms are re-closed as shown in this figure, and the extractor links have raised the cork farther upward.

FIG. 6 is a plan view of an alternate configuration of the cork remover wherein the lever-arms, of zig-zag shape, are pivoted on the rear of the base plate, behind the U-shaped cutout, and then cross each other, and bend back again to handles at a second end. Extractor links are located across the end of an extension of the lever-arms forward from the pivot toward the front of the base plate, and straddle the stopper of a champagne bottle ensconced therein.

### Reference Numerals in Drawings

| Parts (preferred embodiment): | Features: |
|---|---|
| 1: lever-arms (left/right-mirror-image) | 20: U-shaped cutout |
| 2: Extractor links | 21: Centering flange |
| (left/right-symmetrical) | |
| 3: Compression spring | 22: Stop-pin cavity |
| 4: Pivot | 23: Extractor channels |
| 5: Fillister head screw | 24: Extractor link teeth |
| 6: Axle-pin | |
| 7: Torsion spring | |
| 8: Base plate | |
| 9: Stop-pin | |
| Parts (alternate configuration): | |
| 30: Alternate base plate | |
| 31: Alternate lever-arm, right | |
| 32: Alternate lever-arm, left | |

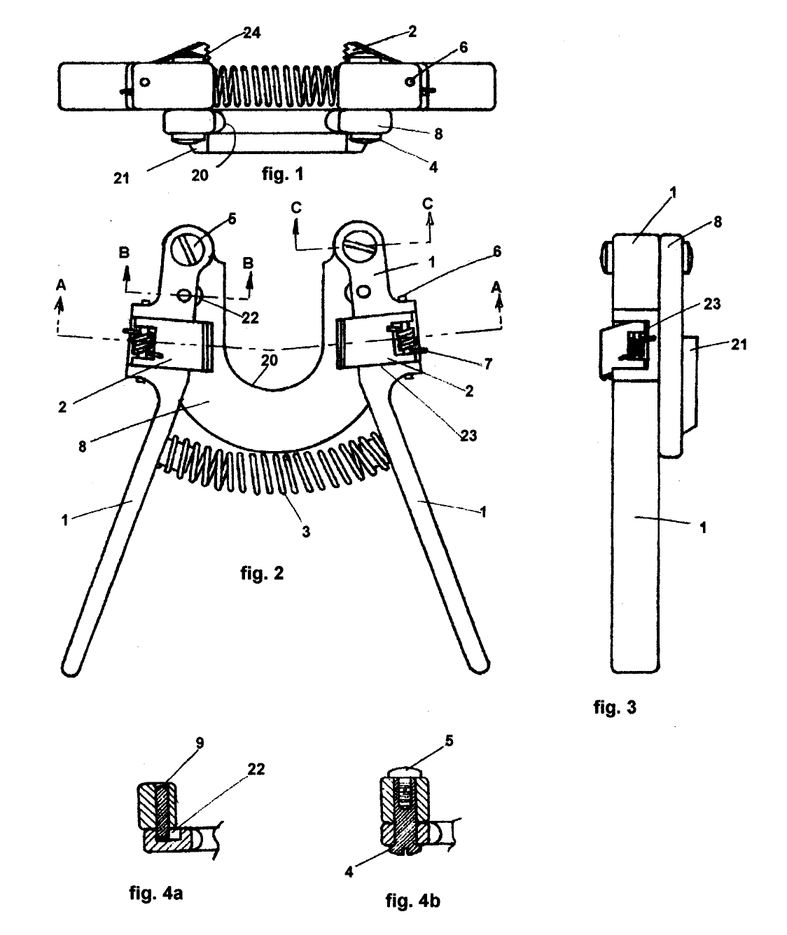

Description: FIGS. 1 Through 5c Preferred Embodiment

The preferred embodiment of this invention is illustrated in the three views of FIG. 1, FIG. 2, and FIG. 3. The lever-arms 1, shown in all three views, are connected to the base plate 8, by two pivots 4 These are kept in place by fillister head screws 5. The pivots 4, are a close but loose fit into the lever-arms 1, and of a length that allows free angular movement of the lever-arms. A compression spring 3, fitted between the lever-arms 1, tends to hold them apart. Stop-pins 9, protruding through the lever-arms into the stop-pin cavities 22 serve to constrain angular movement of the lever-arms to within the comfortable manipulation range of the average adult hand. Extractor links 2, are located in channels 23, formed across the lever-arms at a point in line with the center of the radius of the U-shaped cutout 20. Thus located, the extractor links 2, are moved toward the center of the U-shaped cutout 20, when lever-arms 1, are moved together.

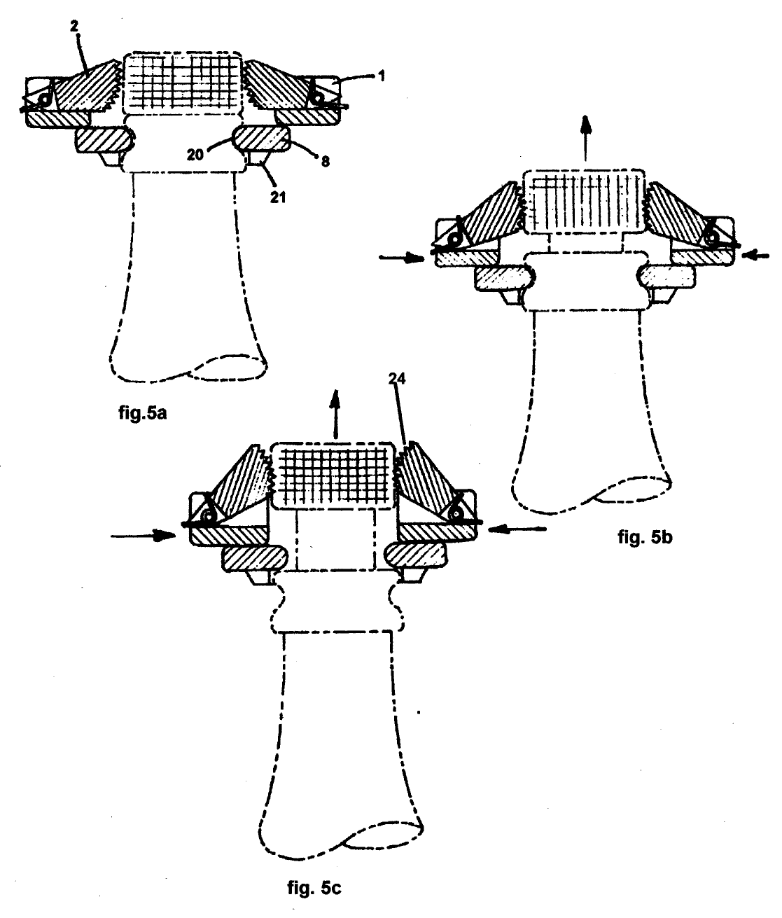

The U-shaped cutout 20, of the base plate is configured to fit into the annulus below the top of a champagne bottle. The extractor links 2, pivot on a small axle-pin 6, fitted into holes across the channel 23, in each lever-arm. A torsion spring 7, around this axle-pin serves to hold each extractor link 2, into position down against the floor of the extractor channel. In this position, the extractor links 2, best seen in FIG. 5a, contact a champagne cork, (shown in phantom) at a point higher than the axle-pin 6, described above. The edge of the extractor link 2, at the point of contact with such stopper is formed of a series of V-shaped teeth 24, or striations, which extend across the face of the extractor link 2. Tips of these teeth form a radius downward and away from the point of contact. As the lever-arms 1, are moved towards each other, (closed), the extractor links are forced against the cork of the stopper, so that a firm, uniform grip over an area on opposite sides of the cork is established. Due to the upward angle of the extractor links, a complementary force is created upward on the free end of the extractor link, and thence the cork, which are moved upward together. Lever ratios are such that a large mechanical advantage is created, and the stopper breaks free and moves up a distance quite easily. Relaxation of hand grip on the lever-arms allows the compression spring 3, to open the lever-arms 1, and the extractor links 2, to be reseated by the torsion springs to the floor of the extractor channels 23, in place for further operation.

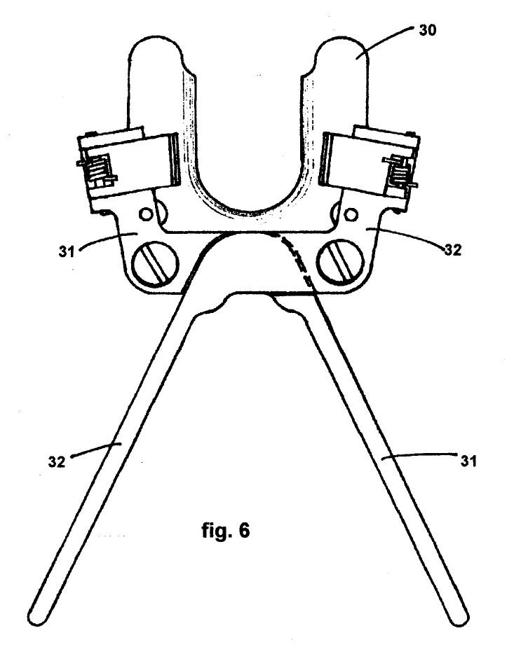

Alternate Embodiment: FIG. 6

The alternate embodiment shown in FIG. 6 has pivot points at the opposite end of the base plate behind the U-shaped cutout. The alternate base plate 30, has pivot holes, and stop cavities relocated to accommodate this change. The zig-zag lever-arms (left 32 and right 31) cross over each other, and then bend back to form handles at a second end. The actuator links are located on an extension forward along, and toward the open end of the U-shaped cutout, straddling the stopper of a bottle of champagne ensconced therein. Action to close these lever-arms results in motion of the extractor links toward the cork in the same way as in the preferred embodiment. These zig-zag lever-arms have cutouts in the area where they overlap, so that they are parallel as in stalled on the base plate. Other parts of the alternate embodiment listed below are identical to those of the preferred embodiment.

| | |
|---|---|
| 2: Extractor links | 3: Compression spring |
| 4: Pivot | |
| 6: Axle-pin | 7: Torsion spring |
| 9: Stop-pin | |
| 5: Fillister head screw | |

Operation: FIGS: 5a, 5b, and 5c.

A number of operational sequences are possible with this tool, but the preferred one is as follows:

a) the wire basket and foil are removed from the bottle

b) the U-shaped cutout 20, of the Cork Remover base plate 8, is positioned in the top bottle annulus, as shown in FIG. 5a, and the lever-arms 1, are firmly closed. The resulting action of the extractor links 2, to grip, and raise the cork upward provides an annular space between the bottle top and the enlarged cap of the cork as shown in FIG. 5b.

c) the Cork Remover is re-positioned with the U-shaped cutout 20, of the base plate 8, fitted into this space created atop the bottle. The centering flange 21, serves to locate the Cork Remover on the bottle to center the stopper in line with the extractor links 2

d) in this position, the lever-arms 1, are again firmly closed, raising the cork stopper farther, and clamping the teeth 24, of the extractor links 2, firmly into the cork as shown in FIG. 5c.

e) at this point, the bottom of the cork will be above the tapered lower portion of the bottle neck, and any slight angular motion of the tool will enable internal pressure to pop the cork out. A firm grip on the lever-arms 1, retains the cork in the tool.

An alternate method suitable for use by wine stewards wherein the champagne is usually provided in an ice bucket is as follows:

a) the wire basket and foil are removed as in the preferred method of operation

b) the Cork Remover is fitted in the bottle top annulus and a napkin is held firmly over the stopper with the free hand

c) repeated closing, and opening, of the lever-arms 1, and the resulting action of the extractor links 2, on the cork, jacks the cork up and out of the bottle, into the napkin.

What is claimed is:

1. A hand tool for compressively gripping, that part of a champagne stopper exposed above the top of a champagne bottle, and for extruding said stopper up, and out of said bottle, comprising:
a) a base plate of metal or plastic, having a U-shaped cutout at a first end, said cutout sized and configured to fit slidably into the annulus found near the top of a champagne bottle, said base plate having two pivot holes adjacent to each side of said U-shaped cutout, and to said first end of said base plate
b) a pair of mirror-image lever-arms with first ends connected pivotably to said pivot holes of said base plate, and extending alongside said U-shaped cutout straddling the stopper of a champagne bottle ensconced therein, then extending further at angles apart to a second end, forming suitable handles for a hand grip, the sides of said lever-arms as installed, which face each other across said U-shaped cutout, are herein designated as the inner sides of said lever-arms, the opposite sides of said lever-arms are therefor designated as the outer sides
c) linkages configured to grip and force out said champagne stopper, said linkages are pivotably attached at first ends of said linkages, to said lever-arms, adjacent to said outer sides of said lever-arms, extending across said lever-arms in line with said champagne bottle stopper, to a predetermined distance beyond said inner sides to second ends of said linkages, the axes of said pivots enabling said second ends of said linkages to pivot upward from seated positions against said lever arms
d) additional means of:
biasing said lever arms to the open, or apart position
limiting angular excursion of said lever-arms to predetermined open, and closed positions
biasing said extractor links to a seated position against said lever-arms
gripping and retaining said champagne stopper as it exits said champagne bottle
e) whereby, a hand tool is assembled which can be manipulated like a pair of ordinary pliers to force out the stopper of a champagne bottle quickly, easily, and ceremoniously, simply by opening and closing said handles of said lever-arms, with no other effort required

2. The hand tool according to claim 1, wherein said linkages are comprised of:
a) an extractor link of predetermined thickness, having a through hole at a first end adjacent to a flat surface, and an arc of striations across an opposite second end, the center of said arc of striations being at a predetermined distance above said flat surface, so that a center line between said through hole and the center of said arc of striations, is at an angle upward from said flat surface
b) axle-pins sized to connect said extractor links pivotably to said lever-arms
c) torsion springs around said axle pins tensioned to bias said extractor-links toward a seated position against said lever-arms

3. The hand tool according to claim 1, wherein the means to bias said lever arms apart is a spring such as a compression spring which can be connected between said lever-arms at a predetermined distance from said first ends of said lever-arms to urge said lever-arms apart

4. The hand tool of claim 1, wherein the means of limiting the angular excursions of said lever-arms are comprised of:
a) stop-pins pressed into said lever-arms, at a predetermined distance from said pivot hole, extending a predetermined distance through said lever arms.
b) cavities in said base plate on each side of said U-shaped cutout, and at the same predetermined distance from said pivot holes in said base plate as in a) above
c) whereby, the cavities are of larger diameter than said stop-pins, angular excursions of said lever-arms are possible to that angle whereat said stop-pins engage a side of one of said cavities.

5. A hand tool for compressively gripping that part of a champagne stopper exposed above the top of a champagne bottle, and of extruding said stopper up and out of said bottle, comprising:
a) a base plate of metal or plastic, having a U-shaped cutout at a first end, said cutout sized and configured to fit slidably into the annulus found at the top of a champagne bottle, said base plate having two pivot holes spaced a predetermined distance apart, and adjacent to a second end of said base plate opposite said first end
b) a pair of mirror-image lever-arms, each of a zig-zag shape, connected pivotably to said pivot holes of said base plate, each with one extension toward said first end of said base plate, said first extensions straddling the stopper of a champagne bottle ensconced therein, the sides of said lever-arms in this extension which face each other across said champagne stopper, are herein designated as the inner sides of said lever-arms, the opposite sides being designated as the outer sides, said lever-arms extend in another direction from said pivot holes at an oblique angle inward, and across each other for a predetermined distance, then extend further at a reverse but lesser angle to second ends to form handles suitable for hand gripping, said lever-arms being cutout where overlapped, to half thickness on that face where they abut,so that as installed on said base plate, they are even, and rise to the same level above the surface of said base plate
c) linkages configured to grip and force out said champagne stopper are pivotably connected at first ends to said lever-arms, adjacent to said outer sides of said lever-arms, extending across said lever-arms inline with said champagne bottle stopper, to a predetermined distance beyond said inner sides to second ends of said linkages, the axes of said pivots enabling said second ends of said linkages to pivot upward, from seated positions against said lever arms.
d) further means of:
biasing said lever arms to the open, or apart position
limiting angular excursion of said lever-arms to predetermined open, and closed positions
biasing said extractor links to a seated position against said lever-arms
gripping and retaining said champagne stopper as it exits said champagne bottle
e) whereby, a hand tool is assembled which can be manipulated like a pair of ordinary pliers to force out the stopper of a champagne bottle quickly, easily, and ceremoniously, by simply opening and closing said handles of said lever-arms, no pulling, or prying is required

6. The hand tool according to claim 5, wherein said linkages are the same as those defined in claim 2.

7. The hand tool tool of claim 5, wherein the means to bias said lever-arms apart are the same as those defined in claim 3.

8. The hand tool according to claim 5, wherein the means of limiting the angular excursions of said mirror-image lever-arms are the same as those defined in claim 4.
